(19) United States
(12) Patent Application Publication
(10) Pub. No.: US 2013/0062447 A1
(43) Pub. Date: Mar. 14, 2013

(54) Modular Coolant Jacket for Rolling Mills

(71) Applicants: David G. Titus, West Boylston, MA (US); Raymond P. Dauphinais, Marlborough, MA (US); Daryl L. Moore, Worcester, MA (US)

(72) Inventors: David G. Titus, West Boylston, MA (US); Raymond P. Dauphinais, Marlborough, MA (US); Daryl L. Moore, Worcester, MA (US)

(73) Assignee: SIEMENS INDUSTRY, INC., Alpharetta, GA (US)

(21) Appl. No.: 13/230,021

(22) Filed: Sep. 12, 2011

(51) Int. Cl. B02C 23/00; B23P 19/00

(52) U.S. Cl. 241/101.2; 29/426.2

(57) ABSTRACT

A modular coolant water jacket has a coolant tube cartridge portion and a selectively separable outer flange portion. Separation of the larger diameter outer flange portion from the cartridge portion facilitates axially oriented insertion and removal of the cartridge tube portion in radially confined spaces. Modular construction also facilitates reuse of the outer flange portion and replacement of only a worn cartridge tube portion.

### BACKGROUND

1. Field

Embodiments of the present invention relate to coolant jackets, often referred to as water jackets, for thermally isolating rolling mill equipment from hot rolled, elongated materials. More particularly, embodiments of the present invention relate to water jackets for thermally isolating bearings of rotating quills in laying heads.

2. Description of the Prior Art

Rolling mills shape hot elongated material that transfers heat to the operating environment. It is desirable to isolate certain roiling mill equipment, for example bearings in rotating machinery, from such heat transfer. In one type of rolling mill application laying heads coil elongated material finished product. The laying heads are fed the elongated material by upstream pinch rolls that are in close proximity to the head's proximal or receiving end. The proximal, end of the laying head often employs a gear driven, necked quill through which the hot elongated material travels within a quill passage. The quill rotates on lubricated bearings that circumscribe the neck portion, with the hot elongated material passing through the neck in close proximity to the bearings. It is desirable to reduce heat transfer to the quill rotational bearings by isolating them from the hot material heat source.

Quill bearings are often thermally isolated with an annular water or other coolant jacket that is interposed within the neck portion between the bearings and hot material. Circulating cooling liquid, such as water, flows through a labrynth annular path within the water jacket, and absorbs heat transferred from the hot material. Thus less heat is transferred to the quill bearings than would occur without the water jacket.

Known water jackets have been constructed with nested, concentric inner and outer tubes, with hot material passing through the inner diameter of the inner tube and cooling water captured between the inner tube outer circumference and the inner diameter of the outer tube. Baffles may be interposed within the annular space between the inner and outer tubes for coolant flow control, often so that the coolest water entering the jacket flows along the inner diameter of the outer tube and then is routed to contact the hotter inner tube. In this way the jacket exterior is maintained at a relatively lower temperature. The nested tubes and baffles are often referred to as a labrynth, due to the coolant flow path.

The axial ends of the water jacket labrynth annular tube structure is capped, with the proximal end of the water jacket that is upstream the elongated material flow path having a flange for attachment to the quill bearing hub. The flange is permanently attached to the labrynth tubular jacket portion.

The flange is relatively larger and has more complex fabrication than the labrynth tubular portion, and often includes passages for fluid communication with coolant inlet and outlet conduits, such as metal braided, hose. The jacket inner passage within the labrynth tubing and/or the flange may also include pneumatic passages for de-scaling the hot elongated material with compressed air as it passes through the quill

Due to the hot environment within the quill neck, often containing abrasive particulant contaminants such as metal scale, the Iabrynth tube portion inner diameter is subjected to wear, and must be periodically replaced. Replacement requires retracting the elongated water jacket from the quill hub bore in a direction generally parallel to the elongated material flow path. However, the elongated material feeding pinch roll assembly discharge outlet is often in axially close proximity to the quill hub and water jacket flange, so that it blocks the flange's clearance needed to retract it from the quill hub. The flange is too wide to enter the pinch roll assembly discharge outlet so there is insufficient radial clearance to accept the flange within the pinch roll feed path. Conversely, the Iabrynth tubing outer diameter is sufficiently small to pass within the pinch roll discharge outlet, but this cannot be done due to permanent attachment of the water jacket flange. Therefore, the pinch roller assembly must be separated from the laying head machinery in order to provide necessary retraction clearance for the one-piece, unitary water jacket. Separation of the pinch roller assembly is time consuming and involves movement of heavy components with multiple repair technicians. Along with the effort and expense of water jacket replacement the rolling mill also suffers economic loss of stopped production. It is desirable to minimize rolling mill downtime and costs associated with water jacket replacement.

### SUMMARY

Accordingly, embodiments of the present invention include a coolant jacket with selectively separable modular coolant cartridge and outer flange portions. The coolant jacket outer flange is separated from the cartridge portion during installation or removal of a coolant jacket from a quill hub, and shifted laterally out of the gap between the laying head quill hub and the pinch roller assembly discharge outlet. This allows the relatively smaller diameter cartridge portion to be inserted or retracted into the quill hub via the pinch roller assembly discharge outlet path, where there is sufficient radial clearance to accept passage of the cartridge labyrinth portion. After the new cartridge portion is inserted into the quill hub, the outer flange portion is attached to the outwardly facing proximal portion of cartridge portion. Thereafter coolant and pneumatic conduits may be attached to the flange portion to complete the repair.

The modular coolant water jacket of the present invention facilitates reuse of the relatively more expensive and permanent outer flange portion, limiting repair expense to the cost of the cartridge labyrinth tubular portion. The modular water jacket of the present invention also eliminates the repair costs and down time associated with removal and replacement of the pinch roller assembly. Thus by using the modular coolant water jacket of the present invention it is possible to complete repairs with fewer repair technicians in less time (hence less production down time) than by use of known one-piece unitized water jackets,

While embodiments herein describe application of the present invention modular coolant water jacket to laying heads, it may be applied to other types of rolling mill water jackets. For example, no matter the type of water jacket application the present invention provides for cost savings by re-using the outer flange portion and limiting replacement to the labrynth or other coolant tubing construction cartridge portion. Modular construction also enhances the possibility of harmonization of coolant cartridge portions and outer flange portions for various coolant jacket applications within a rolling mill, thereby reducing types of spare parts that must be manufactured or retained within repair inventory. The modular coolant water jacket of the present invention can be retrofitted within existing roiling mills and laying heads.

These and other embodiments can be achieved in accordance with the present invention by a rolling mill replaceable coolant jacket cartridge with nested outer and inner sleeves having respective proximal and distal axial ends and defining a coolant passage there between. An end cap is coupled to and seals the respective distal ends of the outer and inner sleeves. The end cap has a passage there through in communication with an interior of the inner sleeve. A cartridge flange is coupled to and seals the respective proximal ends of the outer and inner sleeves. The cartridge flange has a passage there through in communication with the inner sleeve interior. The cartridge flange also has an outer circumference adapted for axially oriented mating engagement with a rolling mill apparatus, and defines a respective coolant inlet and outlet isolated from each other and in communication with the coolant passage. The inlet and outlet are adapted for communication with respective corresponding rolling mill coolant inlet and. outlet sources upon engagement of the cartridge flange and rolling mill apparatus. The cartridge flange also has fastening elements defined therein, adapted for cooperative coupling engagement with the roiling mill apparatus.

Another exemplary embodiment includes a rolling mill laying head incorporating a replaceable coolant jacket cartridge of the present invention. The rolling mill laying head includes a quill rotatively mounted, within a quill hub, having a quill passage therein for passage of rolled, elongated material there through. An annular coolant jacket is within the quill, interposed between the quill passage and the quill hub. The jacket has an outer flange having a neck portion for mating engagement with the quill hub and an outer flange central passage in communication with the quill passage, for passage of elongated material there through. The laying head has a replaceable coolant jacket cartridge having an interior passage therein that is in communication with the outer flange central passage and the quill passage, for passage of elongated material there through. The cartridge defines a coolant passage surrounding at least a portion of the interior passage. Respective engagement surfaces are defined by the outer flange and the cartridge for selective coupling there between. The outer flange and cartridge are further selectively coupled by fastening elements.

The present invention also features a method for replacing a rolling mill coolant jacket by providing a coolant jacket having an outer flange having a neck portion that is adapted for mating engagement with a rolling mill apparatus and an outer flange central passage for passage of elongated material there through. A replaceable coolant jacket cartridge is also provided; the cartridge having an interior passage therein that is adapted for passage of elongated material there through that is in communication with the outer flange central passage. The cartridge defines a coolant passage surrounding at least a portion of the interior passage adapted for communication with a rolling mill coolant source. The provided flange and cartridge also define respective engagement surfaces for selective coupling there between. The next step for performing the method of the present invention is axially inserting the coolant jacket into a rolling mill apparatus and aligning the interior passage thereof with the rolling mill apparatus transport path for elongated material. The next step in performing the process of the present invention is aligning and engaging the outer flange neck portion with a corresponding mating portion of the rolling mill apparatus; followed by coupling the outer flange and cartridge by their respective engagement surfaces. After mutual engagement the outer flange and cartridge are coupled with fastening elements.

The features of the present invention may be applied jointly or severally in any combination or sub-combination by those skilled in the art. Further features of embodiments of the present invention, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

The teachings of the present invention can be readily understood by considering the following detailed description in conjunction with the accompanying drawings, in which:

FIG. 1 shows a side elevational view of a laying head and pinch roller assembly incorporating a coolant jacket, in accordance with an exemplary embodiment of the present invention;

FIG. 2 shows a top plan view of the laying head and pinch roller assembly of FIG. 1, in accordance with an exemplary embodiment of the present invention;

FIG. 3 shows a front elevational view of the laying head and pinch roller assembly of FIG. 1, in accordance with an exemplary embodiment of the present invention;

FIG. 4 shows an elevational cross sectional view of the laying head and pinch roller assembly of FIG. 1, in accordance with an exemplary embodiment of the present invention;

FIG. 5 shows a side elevational view of a modular coolant jacket, in accordance with an exemplary embodiment of the present invention;

FIG. 6 shows a proximal end perspective view of a modular coolant jacket, in accordance with an exemplary embodiment of the present invention;

FIG. 7 shows a perspective cross sectional view of a modular coolant jacket of FIG. 6, in accordance with an exemplary embodiment of the present invention; FIG. 2 shows a top plan view of the laying head and pinch roller assembly of FIG. 1, in accordance with an exemplary embodiment of the present invention; and

FIGS. 8 and 9 are schematic views showing disassembly of the modular coolant jacket within radial and axial confines of a laying head and pinch roll assembly of FIG. 1, in accordance with an exemplary embodiment of the present invention.

To facilitate understanding, identical reference numerals have been used, where possible, to designate identical elements that are common to the figures.

### DETAILED DESCRIPTION

After considering the following description, those skilled in the art will clearly realize that the teachings of the present invention can be readily utilized in rolling mill coolant jackets, including water jackets. The modular coolant jacket of the present invention has a coolant tube cartridge portion and a selectively separable outer flange portion. Separation of the larger diameter outer flange portion from the cartridge tubing portion facilitates axially oriented insertion and removal of the cartridge portion in radially confined spaces, such as those within an elongated material feed path between a pinch roller and laying head. Modular construction also facilitates reuse of the outer flange portion and replacement of only a worn tube cartridge portion.

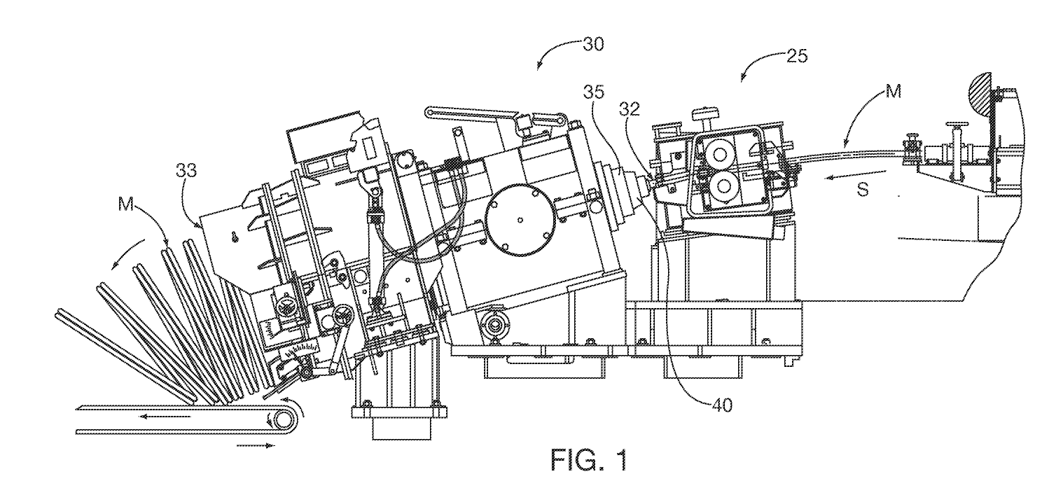

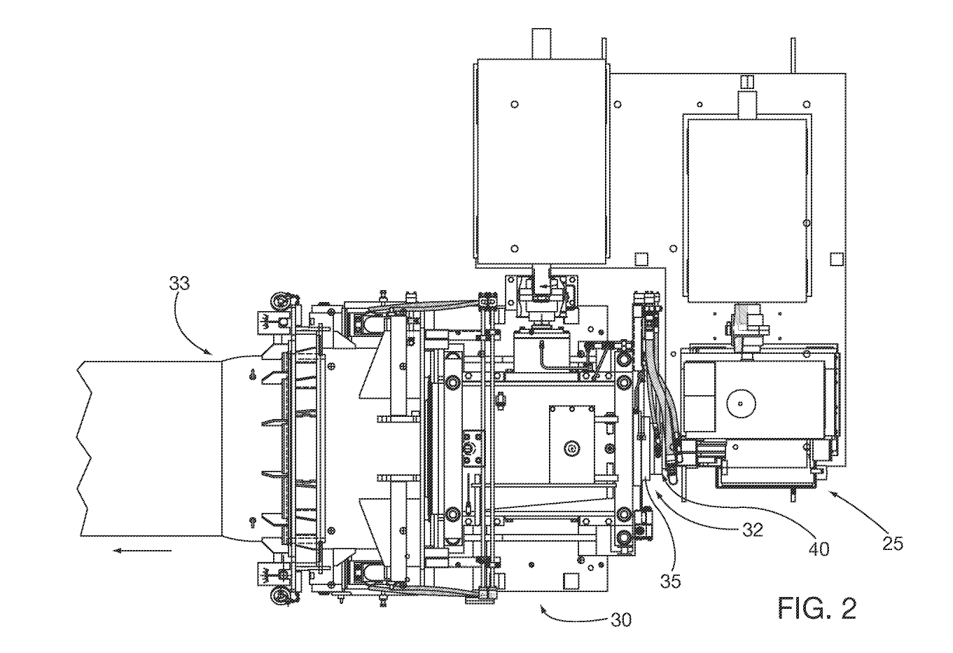

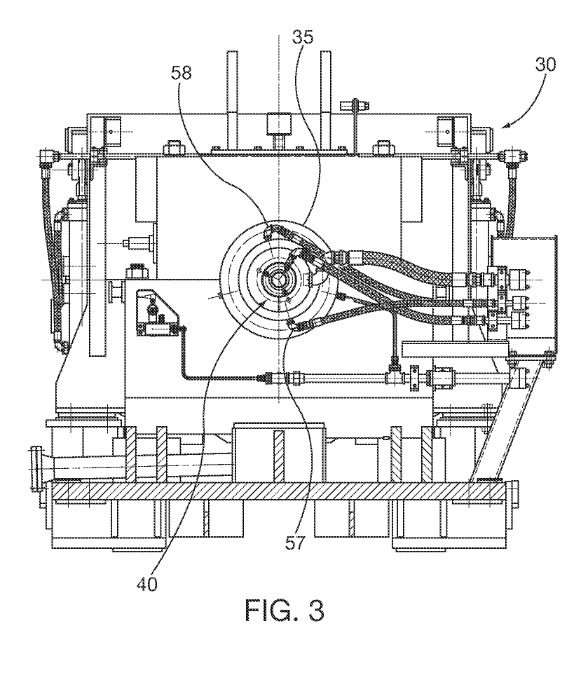

A rolling mill in accordance with an exemplary embodiment of the present invention is shown in FIGS. 1-4, and has a pinch roll assembly 25 that feeds elongated material M at a speed S into a laying head 30 proximal side 32. The elongated material M is subsequently discharged out the laying head 30 distal side 33 in coiled loops. Rotating quill 34 has a necked portion including a quill passage that receives hot elongated material M from the laying head distal side 33 through quill bearing hub 35. Bearings 36 (shown as rolling element bearings) support the rotating bearing hub 35 and quill 34.

Modular coolant or water jacket 40 is coupled within the bearing hub 35 and interposed between the hot elongated material M in the quill passage and the quill bearings 36, providing thermal isolation for the bearings.

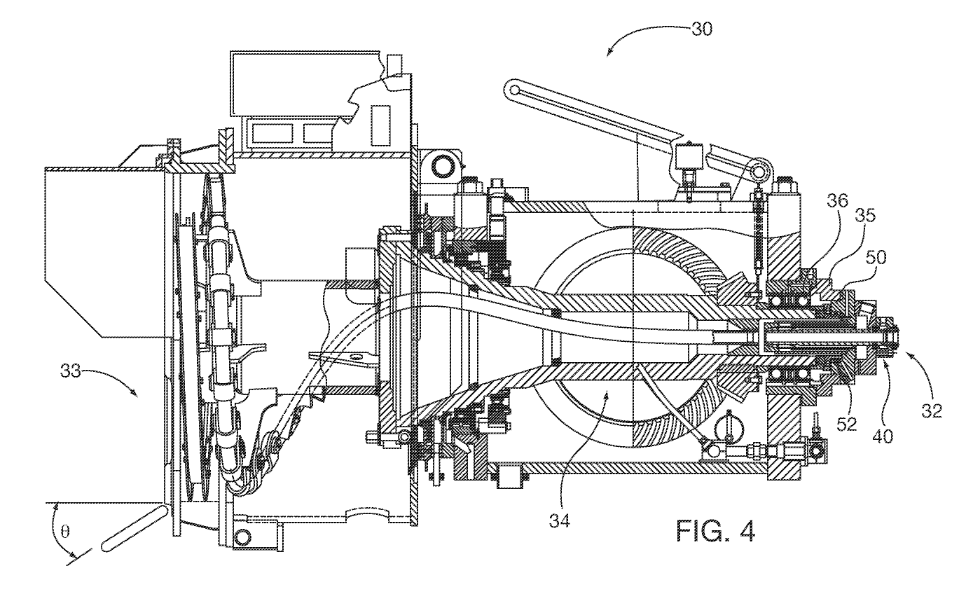

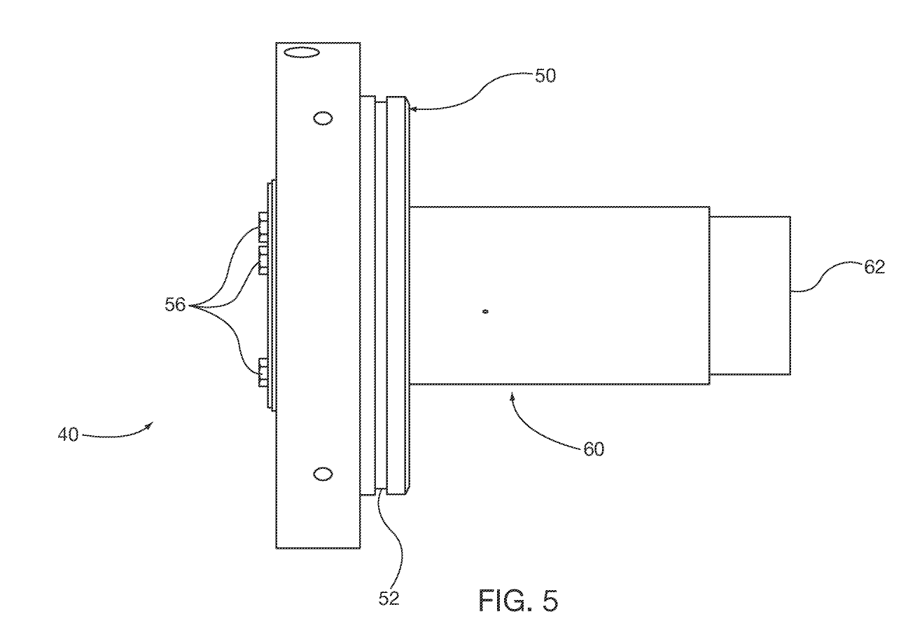

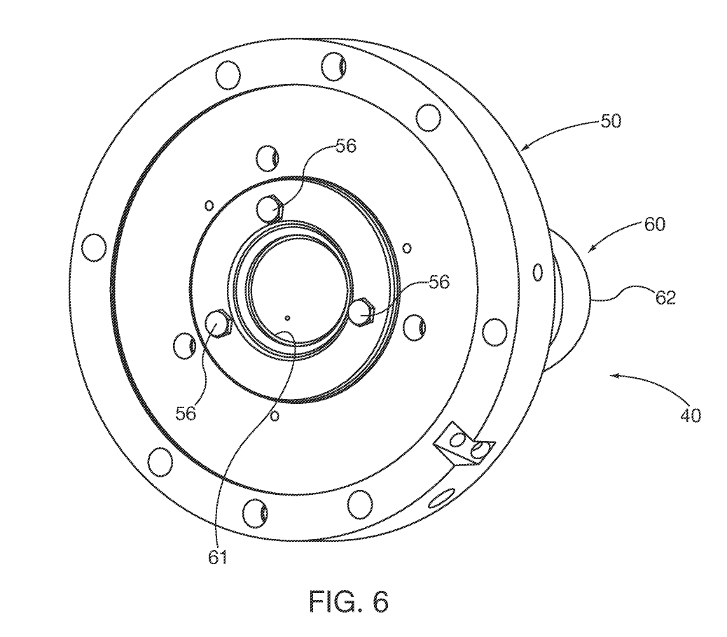

Construction features of the modular coolant jacket 40 is shown in FIGS. 5-7, The cooling jacket has an outer flange portion 50 with a neck portion, including o-ring groove 52 that is inserted into a corresponding female bore defined by the quill bearing hub 35, as shown in FIG. 4. Other known types of outer flange interfaces may be substituted for the mating neck portion and female bore. Outer flange 50 is selectively coupled, by way of a female bore 54 formed, therein to the cartridge portion 60, and with machine screw fasteners 56. Other types of known selectively removable fasteners may be utilized, and the respective flange 50 and cartridge labyrinth 60 portions mutual engagement surfaces may be selectively coupled to each other by other known retention structures, such as a retention collar, flush abutting flanges without mating male and female portions, twist connection with interrupted threads, or threads. Similarly, the engagement surfaces may be reversed with the outer flange 50 defining a male portion that engages a female portion defined by the cartridge portion 60. The outer flange 50 also has coolant inlet 57 and outlet 58 passages for communication with and passage through of coolant, such as water. As is known in the art, the flange 50 may also incorporate pressurized air passages to separate foundary scale from the elongated material M, which are not shown herein.

Coolant jacket cartridge portion 60 has a central interior passage for receipt of and passage of elongated material M therethrough with proximal 61 and distal 62 ends. Cartridge flange 63 on the proximal end of the cartridge labyrinth portion mates with the corresponding female bore 54 formed within the outer flange 50 and retains threaded fasteners 56. The cartridge/labyrinth portion 60 has an outer tubular sleeve 64 and inner tubular sleeve 65 that form between them an annular cooling passage for coolant. While the sleeves 64, 65 shown herein are of symmetrical cylindrical construction with concentric orientation, other sleeve profiles and alignments may be utilized. Baffle 66 is concentrically oriented between the outer and inner tubular sleeves 64, 65 and extends axially a portion of the length of the cartridge labyrinth section 60, thereby directing coolant along a labyrinthine, undulating flow path indicated by the flow arrows F. Coolant enters the cartridge 60 by way of outer flange 50 water inlet 57 the water inlet 67 formed in labyrinth flange 63. Coolant then flows downstream (toward the cartridge distal end 62) along the outer tube sleeve 64 outer circumferential periphery around, the distal end of the baffle 66, and then reverses course upstream along the inner tube's 65 outer surface, toward the water outlet 68 formed within the cartridge flange 63. The water outlet 68 is in communication with the outer flange 50 water outlet 58.

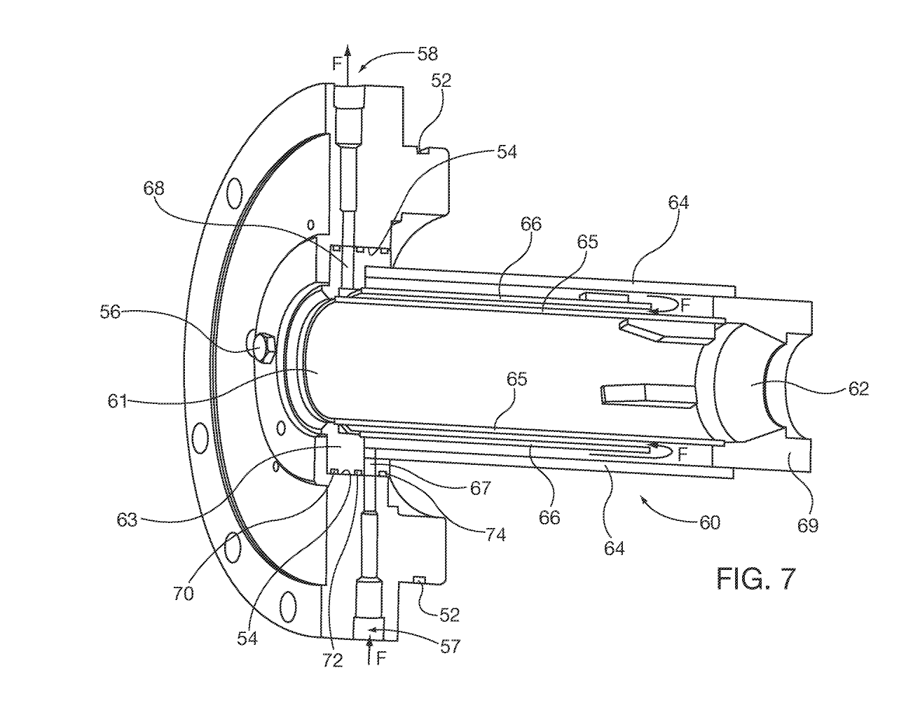

The outer sleeve tube 64 and inner sleeve tube 65 are maintained in concentric orientation by the labyrinth flange 63 and end cap 69, but they may be oriented in non-concentric positions. Similarly, one or more baffles 66 may be oriented in different relative positions in order to establish different desired coolant flow paths. O-rings are retained on the outer circumference of cartridge flange 63 in order to provide for axial and radial coolant flow sealing between the labyrinth portion and the outer flange bore 54. As shown in FIG. 7, proximal o-ring 70 and middle o-ring 72 define the exterior boundaries of the coolant water outlet 58/68. Similarly the middle o-ring 72 and distal o-ring 74 define the exterior boundaries of the coolant water inlet 57/67. Middle o-ring 72 isolates coolant water inlet 67 from cooling water outlet 68.

Modular construction of the coolant water jacket 40 facilitates rapid replacement of worn cartridge labyrinth section 60 from the outer flange section 50 by unscrewing fasteners 56 and axially separating their respective mating engagement surfaces. This allows re-use of the relatively unworn outer flange section 50.

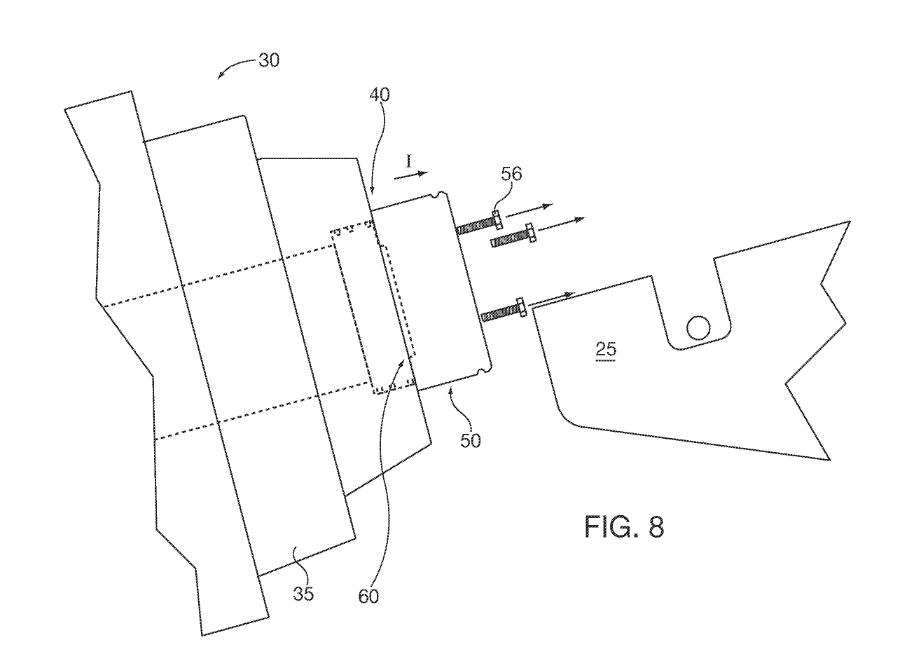

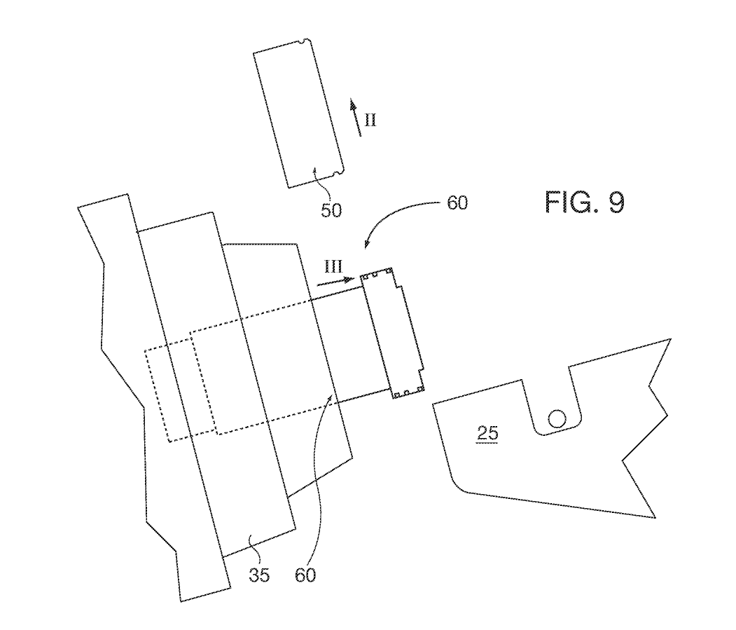

The two-piece separable modular construction of the dimensionally wide diameter outer flange 50 and relatively smaller diameter cartridge labyrinth section 60 also facilities easier field, repair and replacement than previously known unitary construction coolant water jackets. Previously known water jackets could not be disassembled; thus disassembly and separation of the pinch roller assembly was required in order to provide sufficient clearance for separation of the water jacket from the laying head. As shown in FIGS. 8 and 9, the assembled coolant water jacket 40 cannot be retracted axially because water jacket outer flange 50 is too wide to clear the pinch roll assembly 25, However, in the present invention removal of the screws 56 allows separation of the outer flange 50 from the cartridge labyrinth section 60, as indicated, by the arrow I. After such separation, outer flange 50 is shifted laterally (arrow II)in order to clear the gap between the pinch roll assembly 25 and laying head 35. The cartridge section 60 is now retracted axially out of the laying head 35 in the direction of arrow III, where its relatively narrow diameter is sufficiently small to clear the pinch roller assembly 25. Thereafter a service technician replaces the labyrinth cartridge section 60 with a new one, and reinstalls the outer flange 50.

Although various embodiments which incorporate the teachings of the present invention have been shown and described in detail herein, those skilled in the art can readily devise many other varied embodiments that still incorporate these teachings.

What is claimed is:

1. A roiling mill replaceable coolant jacket cartridge, comprising:
nested outer and inner sleeves having respective proximal and distal axial ends and defining a coolant passage there between;
an end cap coupled to and sealing the respective distal ends of the outer and inner sleeves, the end cap having a passage there through in communication with an interior of the inner sleeve; and
a cartridge flange coupled to and sealing the respective proximal ends of the outer and inner sleeves, the cartridge flange having:
a passage there through in communication with the inner sleeve interior;
an outer circumference adapted for axially oriented mating engagement with a rolling mill apparatus, and defining a respective coolant inlet and outlet isolated from each other and in communication with the coolant passage, the inlet and outlet adapted for communication with respective corresponding rolling mill coolant inlet and outlet sources upon engagement of the cartridge flange and rolling mill apparatus; and
fastening elements defined, therein, adapted for cooperative coupling engagement with the rolling mill apparatus.

2. The coolant jacket cartridge of claim 1, further comprising an o-ring retained on the cartridge flange circumference and isolating the inlet and outlet from each other.

3. The coolant jacket cartridge of claim 2, further comprising first, second and third axially separated o-rings retained on the cartridge flange circumference, with the second o-ring isolating the inlet and outlet from each other, and the first and third o-rings isolating the inlet and outlet from an exterior of the coolant jacket cartridge.

4. The coolant jacket cartridge of claim 1, wherein the cartridge flange has a proximal end adapted for abutment against a rolling mill apparatus and the fastening elements are defined therein.

5. The coolant jacket cartridge of claim 4, wherein the fastening elements are threads defined within the cartridge flange proximal end.

6. The coolant jacket cartridge of claim 1, further comprising a baffle oriented between the inner and outer sleeves and interposed between the coolant inlet and outlet.

7. The coolant jacket cartridge of claim 1, further comprising an outer flange having a bore for mating engagement of the cartridge flange outer circumference therein and a neck portion adapted for mating engagement with a rolling mill apparatus.

8. A rolling mill laying head comprising:
a quill rotatively mounted within a quill hub, having a quill passage therein for passage of rolled elongated material there through;
an annular coolant jacket within the quill interposed between the quill passage and the quill hub, the jacket having:
an outer flange having a neck portion for mating engagement with the quill hub and an outer flange central passage in communication with the quill passage, for passage of elongated material there through; and
a replaceable coolant jacket cartridge having an interior passage therein that is in communication with the outer flange central passage and the quill passage, for passage of elongated material there through, the cartridge defining a coolant passage surrounding at least a portion of the interior passage;
respective engagement surfaces defined by the outer flange and the cartridge for selective coupling there between; and
fastening elements for selectively coupling the outer flange and the cartridge.

9. The rolling mill laying head of claim 8, wherein the coolant jacket cartridge further comprises:
nested outer and inner sleeves having respective proximal and distal axial ends and defining the coolant passage there between, an interior of the inner sleeve defining the interior passage;
an end cap coupled to and sealing the respective distal ends of the outer and inner sleeves, the end cap having a passage there through in communication with the inner sleeve interior; and
a cartridge flange coupled to and sealing the respective proximal ends of the outer and inner sleeves, the cartridge flange having:
a passage there through in communication with the inner sleeve interior;
an outer circumference adapted for axially oriented mating engagement with the outer flange engagement surface, and defining a respective coolant inlet and outlet isolated from each other and in communication with the coolant passage, the inlet and outlet adapted for communication with respective corresponding rolling mill coolant inlet and outlet sources passing through the outer flange, upon engagement of the cartridge flange with the outer-flange; and
a portion of the fastening elements are defined by the cartridge flange.

10. The rolling mill laying head of claim 9, the cartridge further comprising an o-ring retained on the cartridge flange circumference and isolating the inlet and outlet from each other.

11. The rolling mill laying head of claim 10, the cartridge further comprising first, second and third axially separated o-rings retained on the cartridge flange circumference, with the second o-ring isolating the inlet and outlet from each other and the first and third o-rings isolating the inlet and outlet from an exterior of the cartridge.

12. The rolling mill laying head of claim 9, wherein the cartridge flange has a proximal end adapted for abutment against the outer flange, and the fastening elements are threaded screws that are captured within female threads defined within cartridge flange.

13. The rolling mill laying head of claim 9, the cartridge further comprising a baffle oriented between the inner and outer sleeves and interposed between the coolant inlet and outlet.

14. The rolling mill laying head of claim 9, wherein the outer flange has a bore for mating engagement of the cartridge flange outer circumference therein and a neck portion adapted for mating engagement with an aperture defined by the quill hub.

15. The rolling mill laying head of claim 14, wherein the outer flange defines coolant source inlet, and outlet passages in communication with a coolant source and the respective cartridge inlet and outlet.

16. The rolling mill laying head of claim 15, the cartridge further comprising first, second and third axially separated o-rings retained on the cartridge flange circumference, with the second, o-ring isolating the inlet and outlet from each other and the first and third o-rings isolating the inlet and outlet from an exterior of the cartridge.

17. The rolling mill laying head of claim 16, the cartridge flange further comprising a proximal end adapted for abutment within the outer flange bore, and the fastening elements are threaded screws that pass through the outer flange and are captured within female threads defined within the cartridge flange.

18. A method for replacing a rolling mill coolant jacket, comprising:
providing a coolant jacket having:
an outer flange having a neck portion that, is adapted for mating engagement with a rolling mill apparatus and an outer flange central passage for passage of elongated material there through; and
a replaceable coolant jacket cartridge having an interior passage therein that is adapted for passage of elongated material there through that is in communication with the outer flange central passage, the cartridge defining a coolant passage surrounding at least a portion of the interior passage adapted for communication with a rolling mill coolant source; and
respective engagement surfaces defined by the outer flange and the cartridge for selective coupling there between;
axially inserting the coolant jacket into a rolling mill apparatus and aligning the interior passage thereof with the rolling mill apparatus transport path for elongated material;
aligning and engaging the outer flange neck portion with a corresponding mating portion of the rolling mill apparatus;
coupling the outer flange and cartridge by their respective engagement surfaces and
coupling the outer flange and cartridge with fastening elements.

19. The method of claim 18, wherein the rolling mill apparatus is a laying head having a quill rotatively mounted within a quill hub, the quill having a quill passage therein for passage of rolled elongated material there through and the coolant jacket is an annular coolant jacket within the quill interposed between the quill passage and the quill hub.

20. The method of claim 19, the coolant jacket further comprising an outer circumference adapted for axially oriented mating engagement with the outer flange engagement surface, and defining a respective coolant inlet and outlet isolated from each other and in communication with the coolant passage, the inlet and outlet adapted for communication with respective corresponding rolling mill coolant inlet and outlet sources passing through the outer flange, upon engagement of the cartridge flange with the outer flange.
